(19) United States
(12) Patent Application Publication
(10) Pub. No.: US 2010/0191599 A1
(43) Pub. Date: Jul. 29, 2010

(54) LOCAL TARGETING ENGINE

(75) Inventors: Shankar Vaidyanathan, Sammamish, WA (US); Bradley Carpenter, Carnation, WA (US); Krista Johnson, Maple Valley, WA (US); George Moore, Redmond, WA (US); Balbir Singh, Redmond, WA (US); Kentaro Toyama, Bangalore (IN); Phani Vaddadi, Issaquah, WA (US); Garrett Vargas, Sammamish, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 12/359,224

(22) Filed: Jan. 23, 2009

(51) Int. Cl. G06Q 30/00; G06F 17/00

(52) U.S. Cl. 705/14.49; 706/47; 715/234

(57) ABSTRACT

Technology is described for local ad targeting. An engine executing on a client computing device may select ads based on rules that can be modified without modifying the engine. The engine can select from advertisements stored locally based on data discovered at the client computing device, such as by observing the user's actions, stored documents, state of the client computing device and/or its peripherals, etc. The technology can employ plug-ins to extend functionality provided by the engine. The technology can include a plug-in manager that manages plug-ins. The technology can also download and manage rules. Each rule can specify what actions to take, such as when an event occurs. When a component of the operating system observes an event, the engine (or a rule executor component associated with the engine) executes each related rule. The technology can thus select ads based on arbitrary events of the operating system, applications, or other components.

### BACKGROUND

Advertisers often desire to target advertisements (“ads”) to users because doing so is more likely to result in a “conversion” of an advertisement to revenue when a user purchases the advertiser's product or service. When a service provider is able to provide some identifying information about a user that an advertiser can use to target an ad, the advertiser is often willing to pay more to the service provider to provide the ad to the user. For example, search engines are able to provide information about a user's current and prior search terms so that an advertiser can target ads relating to the user's search terms or inferred interests.

Legal and ethical restrictions prevent the use of some types of information to target advertisements to users. Because of these restrictions, a service provider may be unable to use information about a user's bank balance, medical history, etc., even if that service provider has access to such information. These restrictions exist because, to use that information, the information would have to be made available to the service provider, such as by transmitting the information to the service provider's server computers or storing the information therein. Doing so may be considered by some to be an invasion of the user's privacy.

However, fewer restrictions exist on how discovered information can be used without transmitting that information to the service provider's computers. For example, if the user has stored this information at the user's personal computer (e.g., desktop, laptop, or handheld computer) there would probably be no legal or ethical restrictions on using that information locally at the user's computer without transmitting that information to the service provider's server computers.

When components are installed in a user's computer, such as to enable providing targeted ads, the components may need to be updated from time-to-time. For example, an advertiser may change its logic for selecting ads. When the logic changes, the components may need to be updated to employ the changed logic, such as by downloading new executable code. However, downloading new code to user computers can lead to problems, such as increased use of network bandwidth, corruption of the executable components, and so forth.

### SUMMARY

Technology is described for local ad targeting. An engine executing on a client computing device may select ads based on rules that can be modified without modifying the engine. The engine can select from advertisements stored locally based on data discovered at the client computing device, such as by observing the user's actions, stored documents, state of the client computing device and/or its peripherals, etc. The technology can employ plug-ins to extend functionality provided by the engine. The technology can include a plug-in manager that manages plug-ins. The technology can also download and manage rules. Each rule can specify what actions to take, such as when an event occurs. When a component of the operating system (e.g., the engine) observes an event, the engine (or a rule executor component associated with the engine) executes each related rule. The technology can thus select ads based on arbitrary events of the operating system, applications, or other components of the client computing device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating an environment in which the technology operates in some embodiments.

FIG. 2 is a block diagram illustrating components of a client computing device adapted for use by the technology in various embodiments.

FIG. 3 is a flow diagram illustrating a routine invoked by the technology to start an ad selector service in some embodiments.

FIG. 4 is a flow diagram illustrating a routine invoked by the technology to load rules in some embodiments.

FIG. 5 is a flow diagram illustrating a routine invoked by the technology to handle events in some embodiments.

FIG. 6 is a flow diagram illustrating a routine invoked by the technology to determine whether an identified plug-in is available in some embodiments.

FIG. 7 is a flow diagram illustrating a routine invoked by the technology to execute a rule in some embodiments.

FIG. 8 is a flow diagram illustrating a routine invoked by the technology to verify plug-ins or rules in various embodiments.

FIG. 9 is a flow diagram illustrating a routine invoked by the technology to execute a sample rule in some embodiments.

### DETAILED DESCRIPTION

Technology is described for local ad targeting. In various embodiments, an engine executing on a client computing device (e.g., a user's computer) selects ads based on rules that can be modified without modifying the engine. The engine can select from advertisements stored locally based on data discovered at the client computing device, such as by observing the user's actions, stored documents, state of the client computing device and/or its peripherals, etc.

The technology can employ plug-ins to extend functionality provided by the engine. A plug-in is a component that can be individually installed or removed dynamically, such as after the engine is installed at the client computing device. Each plug-in can provide services to the engine, such as by communicating with other hardware or software components. As an example, there can be plug-ins to communicate with device drivers, software applications, etc. The computing device may have a plug-in that communicates with printer drivers, Internet browsers, office productivity applications, etc.

The technology can include a plug-in manager that manages plug-ins. The plug-in manager can download plug-ins, verify the plug-ins (e.g., by verifying a digital certificate), remove plug-ins, etc. The technology can also download and manage rules. A rule can be specified in a programming language (e.g., JavaScript, VBScript, etc.) or in a declarative language (e.g., extensible markup language (“XML”)). Each rule can specify what actions to take, such as when an event occurs. Once the technology registers a downloaded rule, the rule executes when a related event occurs. A rule may be registered by storing it in a registry, a local file (e.g., at the client computing device), a remote file (e.g., at a server), or elsewhere. In various embodiments, rules may be stored at a canonical location at the client computing device and thereafter automatically discovered by the technology.

When a component of the operating system (e.g., the engine) observes an event, the engine (or a rule executor component associated with the engine) executes each related rule. A rule may change an event state so that subsequent related rules may not be executed.

The technology can thus select ads based on arbitrary events of the operating system, applications, or other components (e.g., peripherals, device drivers, etc.). As an example, the technology can select an ad based on the state of a peripheral and target the ad based on documents stored on the computing system. As a more specific example, when a printer driver provides an event indicating that the printer's toner is running low on ink, the technology may determine that the user can afford an expensive ink (e.g., based on the user's bank balance stored at the client computing device or based on prior purchase transactions) and provide an ad for the expensive ink. The ad may be placed by a window that describes the low ink condition. Alternatively, if the technology determines that the user generally purchases economical products, the technology may provide an ad for a more economical ink cartridge.

In various embodiments, the user can determine what data the engine has recorded or used and configure the engine so that the engine does not use some of the recorded or used data. As an example, the user may prevent the engine from using health-related data.

The described technology can also be employed to update components (e.g., service components) other than ad selection service components.

The computing devices on which the technology may operate include handheld computing devices, mobile computing devices, stationary computing devices, game consoles, etc.

Several embodiments of the facility are described in more detail in reference to the Figures. The computing devices on which the described technology may be implemented may include one or more central processing units, memory, input devices (e.g., keyboard and pointing devices), output devices (e.g., display devices), storage devices (e.g., disk drives), and network devices (e.g., network interfaces). The memory and storage devices are computer-readable media that may store instructions that implement the importance system. In addition, the data structures and message structures may be stored or transmitted via a data transmission medium, such as a signal on a communications link. Various communications links may be used, such as the Internet, a local area network, a wide area network, or a point-to-point dial-up connection.

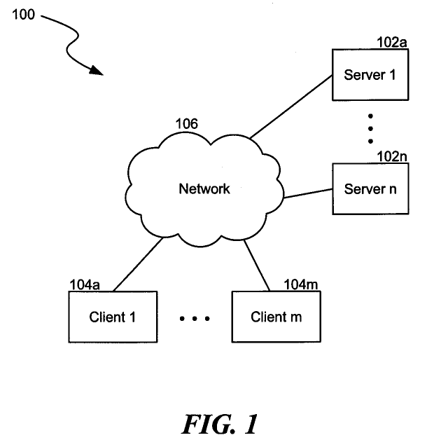

FIG. 1 is a block diagram illustrating an environment in which the technology operates in some embodiments. The environment 100 can include one or more server computing devices 102a to 102n, one or more client computing devices 104a to 104m, and a network 106, such as the Internet or an intranet. The client computing devices may exchange information with the server computing devices. As an example, a client computing device may request content or transactions from a service operating on a server computing device.

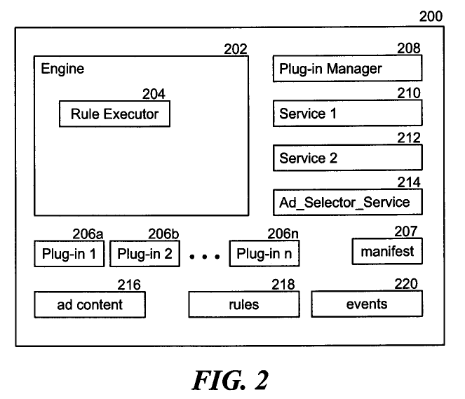

FIG. 2 is a block diagram illustrating components of a client computing device adapted for use by the technology in various embodiments. A client computing device 200 can include an engine 202. The engine 202 can be an executable component that executes rules 218, such as in cooperation with a rule executor 204. A rule can be provided as a sequence of conditions and instructions. A rule may be provided in various programming languages, such as JavaScript, VBScript, etc. A rule may also be provided declaratively, such as by providing a document in a markup language, such as in an extensible markup language (XML). The following provides XML examples of rules:

```
<Rule ID=“12345”>
  ...
  <Variable Name=“currentValue” Type=“number”>1</Variable>
  ...
</Rules>
```

A rule can have flow statements. The following example shows IF, SWITCH, and DO-WHILE statements.

```
<Rule ID=“23456”>
  <If Condition=“client:Language( )==EN”>
    ...
  </If>
</Rules>
<Rule ID=“34567”>
  <Switch>
    <Case condition=“client:Language( )==EN”>
    ...
    </case>
    <Case condition=“client:Language( )==PG”>
    ...
    </case>
    <Default>
    ...
    </default>
  </Switch>
</Rules>
```

The following example shows operations inside rule:

```
<Rule ID=“45678”>
  <Variable Name=“index” Type=“number”>0</Variable>
  <Do While=“index &lt; 10”>
    ...
    <Operation Statement=“Math:Add(index,1)”/>
  </Do>
  <Operation Statement=“ruleValue=true”/>
</Rule>
```

Rules can have other nested rules, as in the examples below:

```
<Rule ID=“56789”>
  <Variable Name=“output” Type=“number”>
    <!-- Execute rule and put return value in variable -->
    <Operation Statement=“Client:Rule(‘BSS003’)”/>
  </Variable>
</Rule>
<Rule ID=“67890”>
  <Variable Name=“output” Type=“number”>
    <!-- Execute inline rule and put return value in variable -->
    <Rule ID=“78901”>
    ...
    </Rule>
  </Variable>
</Rule>
```

The rule engine may work in cooperation with one or more plug-ins, such as with plug-ins 206a, 206b, and 206n. The plug-ins may expose an application program interface (API) that the engine 202 can employ to execute functions provided by the plug-ins. As an example, a rule 218 may request the engine 202 to take a specified action when an event 220 occurs. The engine 202 may then request a plug-in 206a to take the specified action. The following example illustrates taking a special action when the event is the user clicking on an ad.

```
<Rule ID=“98765”>
    <!-- If user clicked on ad, we want to log this and do something
special processing -->
    <If Condition=“client:Event(‘UserClicked’)”>
        ...
        ...
        <!-- Since we have handled the event, let's reset it.-->
          <Operation
Statement=“client:ChangeEventState(‘UserClicked’,
‘0’)”/>
    </If>
</Rule>
```

The engine 202 may also work with one or more services 210, 212, and 214. An ad_selector_service 214 is a service that selects advertisements (“ads”), such as from an ad content component 216. The ad_selector_service may select ads based on various criteria. These criteria may be specified by rules 218. Ads can also be related to rules, as the example below illustrates:

```
<Ad Id=“BSS003”>
  <Creatives>
  ...
  </Creatives>
  <Rules>
    <Rule ID=“12345” />
    <Rule ID=“67890” />
  </Rules>
  ...
</Ad>
```

In this example, an ad having an identifier BSS003 is related to rules having identifiers 12345 and 67890.

The client computing device 200 may also include a plug-in manager 208 that can manage plug-ins, such as by installing, verifying, modifying/replacing, and removing plug-ins. In various embodiments, plug-ins 206a-n and rules 218 may be added, removed, modified, or replaced dynamically, such as by downloading them, copying them from memory external to the client computing device (e.g., optical disks or other transportable media), etc. A manifest 207 may indicate in which order plug-ins are to be executed by the engine 202.

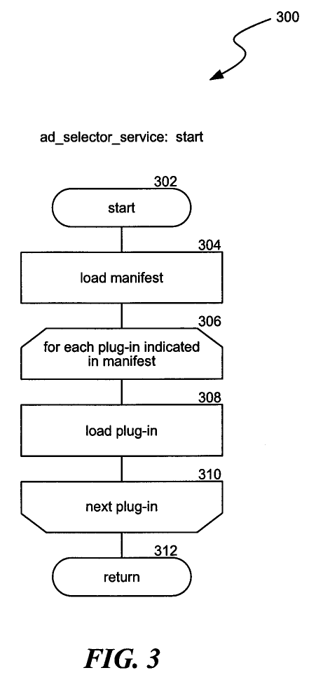

FIG. 3 is a flow diagram illustrating a routine invoked by the technology to start an ad selector service in some embodiments. An ad_selector_service component may invoke the routine 300 when it starts execution. The routine begins at block 302. At block 304, the routine loads a manifest. A manifest is a document that the plug-in manager can install from time to time that describes the plug-ins that the computing system is to install. The manifest may also specify the order in which the downloaded plug-ins are to be executed. An example of a manifest is provided below:

<Plugins>

| | | | |
|---|---|---|---|
| <Plugin | Id=“DisplayEngine” | Version=“2.1919.0.0” | Prefix=“de” |

Code=“advm.microsoft.com/Plugins.aspx?Id=DisplayEngine&amp; ” />

| | | | |
|---|---|---|---|
| <Plugin | Id=“ContextCollection” | Version=“3.2018.0.1” | Prefix=“cc” |

Code=“advm.microsoft.com/Plugins.aspx?Id=ContextCollection” />

| | | | |
|---|---|---|---|
| <Plugin | Id=“Math” | Version=“1.0.2111.0” | Prefix=“math” |

Code=“advm.microsoft.com/Plugins.aspx?Id=Math”/>
</Plugins>

This example manifest has three plug-ins: DisplayEngine, ContextCollection, and Math.

The technology may update the manifest from time to time, such as by downloading it from a server, updating it from a transportable memory (e.g., an optical disk), etc. The manifest may indicate one or more plug-ins. The routine may then load each plug-in, such as in an order indicated by the manifest. In the loop of blocks 306-310, the routine loads the plug-ins indicated by the manifest. At block 306, the routine selects a plug-in indicated by the manifest. At block 308, the routine loads the selected plug-in. As an example, the routine may load a dynamic link library (DLL) that includes the code for the plug-in. At block 310, the routine selects another plug-in. At block 312, the routine returns.

Those skilled in the art will appreciate that the logic illustrated in FIG. 3 and described above, and in each of the flow diagrams discussed below, may be altered in a variety of ways. For example, the order of the logic may be rearranged, substeps may be performed in parallel, illustrated logic may be omitted, other logic may be included, etc.

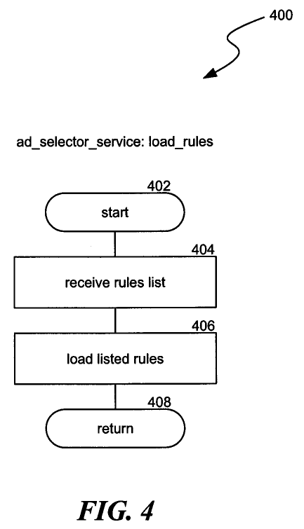

FIG. 4 is a flow diagram illustrating a routine invoked by the technology to load rules in some embodiments. An ad_selector_service component may invoke the routine 400 to load rules. The routine begins at block 402. At block 404, the routine receives a list of rules. At block 406, the routine loads the listed rules. At block 408, the routine returns.

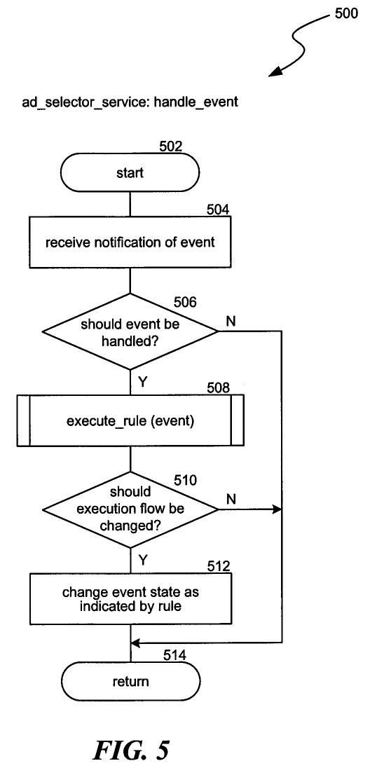

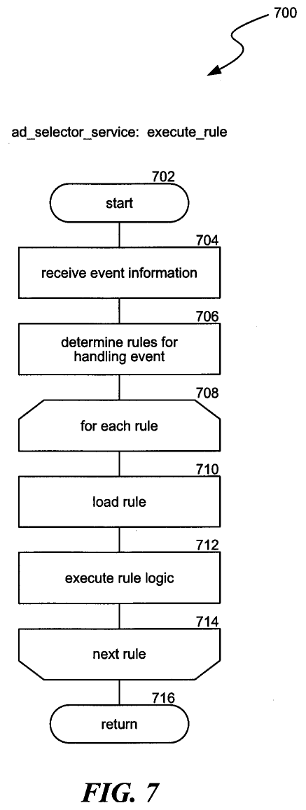

FIG. 5 is a flow diagram illustrating a routine invoked by the technology to handle events in some embodiments. An ad_selector_service component may invoke the routine 500 to handle events. The routine begins at block 502. At block 504, the routine receives a notification of an event. The routine may receive this notification because the ad_selector_service component registered to receive events. Alternatively, the ad_selector_service component may monitor events actively. At decision block 506, the routine determines whether the event should be handled. The routine may make this determination by evaluating the registered rules. As an example, a rule may indicate that the event should be handled. If no rule indicates that the event should be handled, the routine returns at block 514. Otherwise, the routine continues at block 508, where it executes a rule. In various embodiments the routine may invoke an execute_rule subroutine to handle the event and provide an indication of the events to the subroutine. The execute_rule subroutine is described in further detail below in relation to FIG. 7. At decision block 510, the routine determines whether execution flow should be changed. One or more rules may indicate that the execution flow should be changed after the event is handled. If that is the case, the routine continues at block 512. Otherwise, the routine continues at block 514, where it returns. At block 512, the routine changes the event state as indicated by the rule. In some embodiments, a rule may indicate that execution flow should be changed so that other rules that are evaluated later do not also handle the same event. In such a case, the determination made by decision block 510 and the event change described in relation to block 512 may instead be made within the flow of execution described below in relation to FIG. 7. At block 514, the routine returns.

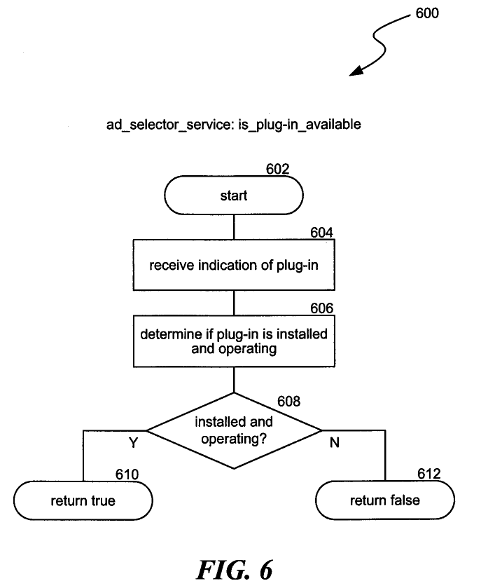

FIG. 6 is a flow diagram illustrating a routine invoked by the technology to determine whether an identified plug-in is available in some embodiments. An ad_selector_service component may invoke the routine 600 to determine whether a plug-in is available. As an example, a rule may apply only when a particular plug-in is available. In such a case, the rule may request the ad_selector_service component to verify that the plug-in is available. The routine begins at block 602. At block 604, the routine receives an indication of the plug-in. As an example, the routine may receive a globally unique identifier that identifies the plug-in. At block 606, the routine determines whether the plug-in is installed and operating. The routine may also determine whether the correct version of the plug-in is installed. As an example, the routine may verify from a registry (either local or remote) whether the installed version is the most up-to-date version. At decision block 608, if the correct version of the plug-in is installed and operating, the routine continues at block 610, where it returns true. Otherwise, the routine continues at block 612, where it returns false.

The technology may provide a similar function to determine whether a function is provided by a plug-in. As an example, the following rule may evaluate whether a printer plug-in (“ptrpl”) provides an “OutOfInk” function:

```
<Rule ID=“12346” Type=“abc”>
  <rl:if Condition=“client:IsFunctionAvailable(‘ptrpl:OutOfInk’)”>
  ...
  </rl:if>
</Rules>
```

FIG. 7 is a flow diagram illustrating a routine invoked by the technology to execute a rule in some embodiments. An ad_selector_service component may invoke the routine 700 to execute a rule. The routine begins at block 702. At block 704, the routine receives event information. As an example, the routine may receive an indication of the event that is being handled by the handle_event routine when it invoked the execute_rule subroutine. At block 706, the routine determines which rules relate to the event. As an example, the routine may have a list of rules that have registered to handle the events. In the loop of block 708-714, the routine executes rule logic for each such rule. At block 708, the routine selects a rule. At block 710, the routine loads the selected rule. At block 712, the routine executes logic associated with the rule. The logic may be provided in various programming languages, such as JavaScript, VBScript, etc. The logic may also be provided as an executable component. At block 714, the routine selects another rule. At block 716, the routine returns.

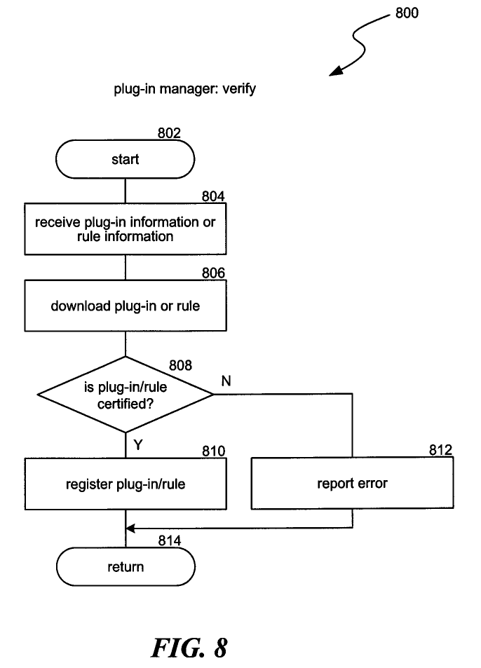

FIG. 8 is a flow diagram illustrating a routine invoked by the technology to verify plug-ins or rules in various embodiments. A plug-in manager component (or other component that downloads plug-ins and/or rules) may invoke the routine 800 to verify a plug-in or rule. The routine begins at block 802. At block 804, the routine receives plug-in information or rule information. As an example, a component may request that a plug-in or rule be downloaded and registered. At block 806, the routine downloads the indicated plug-in or rule. At decision block 808, the routine verifies that the plug-in or rule is certified. As an example, the routine may verify digital certificate included with the download plug-in or rule. If the plug-in or rule is certified, the routine continues at block 810. Otherwise, the routine continues at block 812. At block 810, the routine registers the download plug-in or rule and then returns at block 814. At block 812, the routine may report an error, and then returns at block 814.

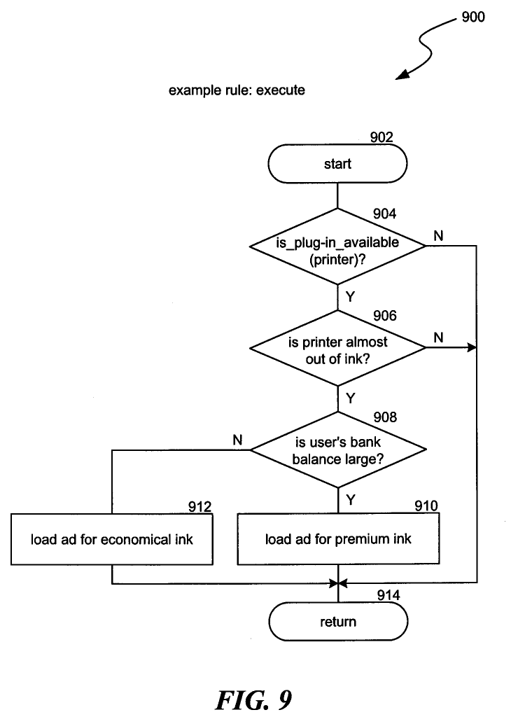

FIG. 9 is a flow diagram illustrating a routine invoked by the technology to execute a sample rule in some embodiments. A rule executor component may invoke the routine 900 to execute logic of the rule, e.g., when the operating system emits a “printer low ink” event. The illustrated rule may load an advertisement to display to a user based on the condition of the user's printer and bank balance. The routine begins at block 902. At decision block 904, the routine determines whether a printer plug-in is available. If the printer plug-in is available, the routine continues at decision block 906. Otherwise, the routine returns at block 914. At decision block 906, the routine determines whether the printer is almost out of ink. As an example, the routine may request a printer driver to provide this information. If the printer is almost out of ink, the routine continues at decision block 908. Otherwise, the routine returns at block 914. At decision block 908, the routine evaluates whether the user's bank balance is large. As an example, the routine may view the user's browser history, documents stored locally at the client computing device, etc. If the user's bank balance is large, the routine continues at block 910. Otherwise, the routine continues at block 912. At block 910, the routine loads an ad for a premium ink that is compatible with the user's printer and then returns at block 914. At block 912, the routine loads an ad for a more economical ink that is compatible with the user's printer. The routine then returns at block 914 so that a component can display the ad to the user.

Because the ad selection can occur locally, different users using different applications may see different ads. For example, a wealthy user may see different ads than a less wealthy user. A user with a very sophisticated computer may see different ads than a user with a less sophisticated computer.

The technology thus provides an ability to frequently change how advertisements are selected to incorporate new features without updating client executable components.

In various embodiments, the technology can support versioning of plug-ins and rules. As an example, an enterprise may disallow a newer version of a plug-in or rule until the enterprise tests the plug-in or rule for compatibility, security, or other reasons.

In various embodiments, the technology may track ad selection. As an example, when a user selects an ad (e.g., by clicking a mouse button when the mouse pointer is “over” an ad), the technology can log the selection in a local storage. When the user next connects to a network, the technology may transmit the selected ads to a server.

Various additional embodiments will now be described. These embodiments may operate independently or in association with one another.

The technology may perform a method comprising: receiving a rule, the rule specifying a condition and an action wherein the condition is based on an event; registering the received rule; receiving an indication that the event has occurred; identifying the rule as associated with the event; determining that the condition indicated by the rule is satisfied; and causing the action to be performed, wherein receiving the rule does not require an executable engine to be modified when the rule is received. The method can include receiving a plug-in; registering the received plug-in; determining that the action specified by the rule is associated with the plug-in; and invoking a function provided by the plug-in to cause the action to be performed. The plug-in may be associated with a device driver. The method can include receiving a plug-in; and registering the received plug-in, wherein the event is raised by the plug-in when the plug-in determines that another component has raised an event. The other component can be a hardware component. The other component can be a software component. The action can be to display an advertisement. The rule can be specified in an extensible markup language. The rule can be specified in a scripting language. The method can include evaluating the received rule at a client computing device that stores information private to a user to select an advertisement based on the private information such that no aspect of the rule is evaluated by a server computing device.

The technology can include one or more computer-readable storage media collectively storing computer-executable instructions that, when executed, cause a computing system to perform a method, the method comprising: receiving a first plug-in; verifying the first plug-in; if the first plug-in is verified, registering the first plug-in; if an event occurs, determining whether the event is associated with the first plug-in; if the event is associated with the plug-in and a condition specified by the event is satisfied, causing the first plug-in to take an action. The action can be to query an application for data. The method can include selecting an advertisement based on the data. The data may be private to a user and may not be transmitted to an advertiser and may also not be transmitted to a service provider via which the advertiser advertises. The method can include receiving a manifest indicating two or more plug-ins and an order for executing the two or more plug-ins; receiving a second plug-in that is different from the received first plug-in; and if the event occurs, executing the plug-ins in the order indicated by the manifest. The plug-in may be implemented as a dynamic link library.

The technology may include a system for enabling local ad targeting, comprising: an engine including a rule executor wherein the rule executor evaluates one or more rules wherein dynamically adding a rule does not require modification of executable code of the engine; a first plug-in that exposes an application program interface to the engine that includes a function name wherein when the function is invoked by the engine, a first logic is executed; a second plug-in that also exposes the application program interface to the engine that also includes the function name, wherein when the function is invoked by the engine, a second logic is executed; and a manifest that can be updated from time-to-time wherein the manifest indicates a list of plug-ins accessible by the engine. The dynamically added rule may specify how an advertisement is to be selected. The first plug-in can cause an action to occur when an event occurs and the rule executor determines that the event has occurred and the dynamically added rule specifies that the action is to occur. The second plug-in can retrieve a document stored at a client computing device wherein the document contains information private to a user and a rule specifies that the information is to be used to select an advertisement. The document can be, e.g., Internet browser history, Internet browser cookies, office productivity application documents, databases, and any other document type.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method performed by a computing system, comprising:
receiving a rule, the rule specifying a condition and an action wherein the condition is based on an event;
registering the received rule;
receiving an indication that the event has occurred;
identifying the rule as associated with the event;
determining that the condition indicated by the received rule is satisfied; and
causing the action to be performed,
wherein receiving the rule does not require an executable engine to be modified when the rule is received.

2. The method of claim 1 further comprising:
receiving a plug-in;
registering the received plug-in;
determining that the action specified by the rule is associated with the plug-in; and
invoking a function provided by the plug-in to cause the action to be performed.

3. The method of claim 2 wherein the plug-in is associated with a device driver.

4. The method of claim 1 further comprising:
receiving a plug-in; and
registering the received plug-in, wherein the event is raised by the plug-in when the plug-in determines that another component has raised an event.

5. The method of claim 4 wherein the other component is a hardware component.

6. The method of claim 4 wherein the other component is a software component.

7. The method of claim 1 wherein the action is to display an advertisement.

8. The method of claim 1 wherein the rule is specified in an extensible markup language.

9. The method of claim 1 wherein the rule is specified in a scripting language.

10. The method of claim 1 further comprising evaluating the received rule at a client computing device that stores information private to a user to select an advertisement based on the private information such that no aspect of the rule is evaluated by a server computing device.

11. A computer-readable storage medium storing computer-executable instructions that, when executed, cause a computing system to perform a method, the method comprising:
receiving a first plug-in;
verifying the first plug-in; and
if the first plug-in is verified,
registering the first plug-in;
if an event occurs, determining whether the event is associated with the first plug-in; and
if the event is associated with the plug-in and a condition specified by the event is satisfied, causing the first plug-in to take an action.

12. The computer-readable storage medium of claim 11 wherein the action is to query an application for data.

13. The computer-readable storage medium of claim 12 further comprising selecting an advertisement based on the data.

14. The computer-readable storage medium of claim 13 wherein the data is private to a user and is not transmitted to an advertiser and is also not transmitted to a service provider via which the advertiser advertises.

15. The computer-readable storage medium of claim 11 further comprising:
receiving a manifest indicating two or more plug-ins and an order for executing the two or more plug-ins;
receiving a second plug-in that is different from the received first plug-in; and
if the event occurs, executing the plug-ins in the order indicated by the manifest.

16. The computer-readable storage medium of claim 11 wherein the first plug-in is implemented as a dynamic link library.

17. A system for enabling local ad targeting, comprising:
an engine including a rule executor wherein the rule executor evaluates one or more rules wherein dynamically adding a rule does not require modification of executable code of the engine;
a first plug-in that exposes an application program interface to the engine that includes a function name wherein when the function is invoked by the engine, a first logic is executed;
a second plug-in that also exposes the application program interface to the engine that also includes the function name, wherein when the function is invoked by the engine, a second logic is executed; and
a manifest that can be updated from time-to-time wherein the manifest indicates a list of plug-ins accessible by the engine.

18. The system of claim 17 wherein the dynamically added rule specifies how an advertisement is to be selected.

19. The system of claim 17 wherein the first plug-in can cause an action to occur when an event occurs and the rule executor determines that the event has occurred and the dynamically added rule specifies that the action is to occur.

20. The system of claim 17 wherein the second plug-in can retrieve a document stored at a client computing device wherein the document contains information private to a user and a rule specifies that the information is to be used to select an advertisement.
